(19) United States
(12) Patent Application Publication
(10) Pub. No.: US 2024/0253325 A1
(43) Pub. Date: Aug. 1, 2024

(54) FROST-RESISTANT SURFACES WITH MACRO-TEXTURED PERIODIC LATTICE STRUCTURES

(71) Applicant: Northwestern University, Evanston, IL (US)

(72) Inventors: Asma Ul Hosna Meem, Evanston, IL (US); Christian John Machado, Evanston, IL (US); Kyoo-Chul Kenneth Park, Evanston, IL (US); Jian Cao, Evanston, IL (US); Benjamin Stern, Evanston, IL (US)

(21) Appl. No.: 18/424,059

(22) Filed: Jan. 26, 2024

Related U.S. Application Data
(60) Provisional application No. 63/481,682, filed on Jan. 26, 2023.

(51) Int. Cl. B32B 3/12; B32B 15/04; B32B 15/08; B32B 27/08

(52) U.S. Cl. CPC B32B 3/12; B32B 15/043; B32B 15/08; B32B 27/08; B32B 2255/06; B32B 2255/10; B32B 2255/20; B32B 2307/724

(57) ABSTRACT

A method of forming a textured surface to prevent frost buildup includes forming a substrate. The method also includes forming a plurality of three-dimensional structures that attach to the substrate such that valleys are formed in between the three-dimensional structures. The method further includes controlling dimensions of each of the plurality of three-dimensional structures to generate a concentration gradient that forms as a result of a saturation vapor pressure difference between solid condensate and liquid condensate that forms on the textured surface. The concentration gradient causes evaporation of the liquid condensate in the valleys that occur between the plurality of three-dimensional structures. The vapor diffusion control provided by the three-dimensional structures can be further enhanced by the application of a moisture-absorbing coating to the planar bottom region/valleys between these structures.

### CROSS-REFERENCE TO RELATED APPLICATION

The present application claims the priority benefit of U.S. Provisional Patent App. No. 63/481,682 filed on Jan. 26, 2023, the entire disclosure of which is incorporated herein by reference.

### BACKGROUND

Frost formation on various surfaces can cause energy inefficiency in many different practical fields. For example, frost formation on airplane wings, wind turbine blades, various sensor surfaces, cement surfaces, etc. can pose a serious risk and/or result in poor thermal performance of the heat exchangers used in those systems.

### SUMMARY

An illustrative method of forming a textured surface to prevent frost buildup includes forming a substrate. The method also includes forming a plurality of three-dimensional structures that attach to the substrate such that valleys are formed in between the three-dimensional structures. The method further includes controlling dimensions of each of the plurality of three-dimensional structures to generate a concentration gradient that forms as a result of a saturation vapor pressure difference between solid condensate and liquid condensate that forms on the textured surface. The concentration gradient causes evaporation of the liquid condensate in the valleys that occur between the plurality of three-dimensional structures.

In some embodiments, the method also includes applying a coating to the valleys formed in between the three-dimensional structures. One embodiment includes applying the coating to the plurality of three-dimensional structures. The method also includes altering, by the coating, an overall diffusion field of the textured surface by adsorbing or desorbing vapor from the atmosphere. In an illustrative embodiment, the coating comprises a moisture absorbent micro/nanomaterial. One such moisture absorbent material is graphene oxide (GO).

In one embodiment, the three-dimensional structures are polygons, and the controlled dimensions include a height of the side walls of the polygon (h) and a length of a side of the polygon (L). In another embodiment, the three-dimensional structures are hexagonal in shape. In another embodiment, the three-dimensional structures are square, rectangular, circular, triangular, or any other polygon in shape. In an illustrative embodiment, the method includes forming a periodic lattice structure on the substrate with the three-dimensional structures.

An illustrative textured surface includes a substrate and a plurality of three-dimensional structures attached to the substrate. Dimensions of each of the plurality of three-dimensional structures are controlled to generate a concentration gradient that forms as a result of a saturation vapor pressure difference between solid condensate and liquid condensate on the textured surface. The textured surface also includes valleys that are formed in between the plurality of three-dimensional structures, where the concentration gradient causes evaporation of the liquid condensate in the valleys.

In one embodiment, the texture surface includes a coating applied to the valleys formed in between the three-dimensional structures. In one embodiment, the coating is also applied to the valleys in between the plurality of three-dimensional structures. In an illustrative embodiment, the coating alters an overall diffusion field of the textured surface by adsorbing or desorbing vapor from the atmosphere. In one embodiment, the coating comprises a moisture absorbent nanomaterial. In another embodiment, the coating comprises graphene oxide (GO).

In another embodiment, the three-dimensional structures are polygons, and the controlled dimensions include a height of the side walls of the polygon and a length of a side of the polygon. In one embodiment, the three-dimensional structures are hexagonal in shape. In another embodiment, the three-dimensional structures are square, rectangular, circular, or triangular in shape. In an illustrative embodiment, the three-dimensional structures form a periodic lattice structure on the substrate.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 depicts a surface that includes a periodic lattice of macro-textures in accordance with an illustrative embodiment.

FIG. 2 is a top view of a surface with a periodic lattice of macro-textures in accordance with an illustrative embodiment.

FIG. 3 depicts experiments conducted on various metallic samples in accordance with an illustrative embodiment.

FIG. 4A depicts experiments conducted with metallic samples having macro-textures with varying sidewall height h in accordance with an illustrative embodiment.

FIG. 4B is a top view of frost-free valley regions of the experiments conducted with metallic samples having macro-textures with varying sidewall height h in accordance with an illustrative embodiment.

FIG. 5 is a table that depicts geometric and material information regarding the different samples tested in accordance with an illustrative embodiment.

FIG. 6 is a table that depicts all relevant information regarding the experiments conducted in accordance with an illustrative embodiment.

FIG. 7A shows the results of the first experiment after 1 hour in accordance with an illustrative embodiment.

FIG. 7B shows the results of the first experiment after 2 hours in accordance with an illustrative embodiment.

FIG. 7C shows the results of the first experiment after 2.5 hours in accordance with an illustrative embodiment.

FIG. 8 depicts results of a second experiment with a polymeric sample after t=1 hour and, after t=2 hours in accordance with an illustrative embodiment.

FIG. 9 depicts results of a third experiment with two different polymeric samples after t=1 hour and, after t=2.5 hours in accordance with an illustrative embodiment.

FIG. 10 depicts results of a fourth experiment with five different metallic samples of varying side wall length and side wall height in accordance with an illustrative embodiment.

FIG. 11 depicts results of a fifth experiment with two metallic samples of varying side wall length in accordance with an illustrative embodiment.

FIG. 12 depicts results of a sixth experiment with two metallic samples of varying side wall height in accordance with an illustrative embodiment.

FIG. 13 depicts results of a seventh experiment with a metallic sample in accordance with an illustrative embodiment.

FIG. 14 depicts results of an eighth experiment with two metallic samples in accordance with an illustrative embodiment.

FIG. 15 depicts results of a ninth experiment with two different metallic samples with a PDMS coating in accordance with an illustrative embodiment.

FIG. 16 depicts results of a tenth experiment with a metallic sample with forced convection in accordance with an illustrative embodiment.

FIG. 17 depicts results of an eleventh experiment with a metallic sample with relative humidity variation in accordance with an illustrative embodiment.

FIG. 18 depicts results of a twelfth experiment with one metallic and one polymeric sample with GO coating and with PDMS coating, one polymeric sample to show thermal gradient effect, in accordance with an illustrative embodiment.

FIG. 19 depicts simulation results of a temperature profile comparison between polymeric and metallic samples in accordance with an illustrative embodiment.

FIG. 20 depicts simulation results of a diffusive flux distribution between polymeric and metallic samples (geometry only without GO) in accordance with an illustrative embodiment.

FIG. 21 depicts simulation results of a distribution of c/cₛₐₜᵤᵣₐₜᵢₒₙ (normalized concentration field) (geometry only without GO) for polymeric and metallic samples in accordance with an illustrative embodiment.

FIG. 22 depicts simulation results of a distribution of c/cₛₐₜᵤᵣₐₜᵢₒₙ (normalized concentration field) of a metallic sample with a GO coating in the bottom of the hexagon in accordance with an illustrative embodiment.

FIG. 23 quantifies an unfrosted areal portion of a metallic sample surface from an experiment (with no GO coating) in accordance with an illustrative embodiment.

FIG. 24 depicts that a 100% unfrosted areal portion can be achieved at the bottom surface of a metallic sample (with no GO coating) in accordance with an illustrative embodiment.

### DETAILED DESCRIPTION

Over the years, numerous research studies have been conducted to address the issue of unwanted frost formation on surfaces. Many such previous attempts to develop anti-ice or anti-frost surfaces were based on nano-/micro-structured surfaces that are difficult to manufacture. Additionally, the efficiency of such nano/micro-structured surfaces to prevent frost formation for a long period of time is low. To address the existing challenges of resisting/controlling frost formation, the effectiveness of macro-textures have been investigated.

In the present application, the inventors aim to utilize the full potential of macro-textures in resisting frost formation to develop a functional, durable, and scalable surface framework that can resist frost-formation for a longer period of time and over a large planar/flat surface, when compared to traditional surfaces. Another goal is to form such surfaces using advanced manufacturing processes that can control the local/global heat transfer and density of the macro-textured surface, such as additive manufacturing, sheet metal forming, mechanical pressing, injection molding, and cutting process. In an illustrative embodiment, a frost-resistant surface was developed by having a periodic lattice structure of macro-textures. The macro-textures in one embodiment can be hexagonal shapes. In alternative embodiments, different shapes can be used such as square, rectangle, octagon, or combinations of various polygons, circle, oval, etc. In some embodiments, a graphene oxide coating is applied to the surface for enhancing the frost-resisting performance to get planar frost-free regions on the surface. In one embodiment, the proposed textured-surface combines a macro-textured topology with a two-dimensional heterogeneous material to create a region that is stable in repelling the formation of condensable vapors, and thus prevents and provides control over frost formation.

More specifically, described herein is a large area surface that can resist frost formation or other condensable vapor formation for a long period of time. In one embodiment, the surface includes three-dimensional, millimetric, macro-textures arranged in a periodic lattice that can be prepared via different manufacturing processes, such as additive manufacturing, sheet metal forming, mechanical pressing, injection molding, and cutting process. In some embodiments the surface is coated with a two-dimensional, hygroscopic nano-material coating to enhance the frost-resistance provided by the macro-textures. Alternatively, the coating may not be used.

In an illustrative embodiment, a frost-resistant three-dimensional surface can be formed by incorporating hexagonal-shaped macro-textures in a closely packed array in a periodic manner. A single 3D hexagonal macro-texture was formed by bounding a hexagonal-shaped region by a side wall. As a result, a hexagonal valley is formed in between the side walls. Such a single macro-texture experimentally demonstrated its ability to resist frost formation in the valley region, while confining the frost only on the top surfaces of the side walls, by manipulating the vapor diffusion flux through two mechanisms: (1) millimeter-scale walls induce focused diffusive flux of vapor to the top surface of the walls, and (2) the difference in saturation vapor pressure of liquid and solid phase of the condensable material. The diffusion-controlled frost formation is initiated with a condensation of larger water droplets on the top surface of the side walls when the system is placed in a super-saturated, below-freezing temperature cold air. Subsequently, frost is only formed on the top surfaces of the side walls, suppressing frost formation in the valley region for a significant amount of time.

Thus, when multiplied, the hexagonal-shaped, periodic lattice structure results in a planar surface that is able to resist frost-formation over a larger space for a significant amount of time. The valley region can be covered with single/multiple layers of a two-dimensional (2D), permeable, hygroscopic, nano-coating material (e.g., graphene oxide or GO, or other material with similar vapor-absorbing properties) that can absorb moisture, thus keeping the valley region frost-free for a longer period of time. The thickness of such a coating can vary from micrometric to millimetric range. Such a coating is configured to manipulate an overall diffusion field of the textured surface by adsorbing or desorbing vapor from the atmosphere. The surface texture includes several design parameters that are defined and that can be manipulated to control the frost prevention effect on the surface. The design parameters include the length (L) of the side wall of the hexagon, height (h) of the side wall, and the thickness of the 2D material coating. The value of the parameters can be varied across a given surface to provide different frost-resisting behaviors over the surface. The height and length of the side walls are controlled in such a way that the freezing of condensate begins at the top surface of the side walls, and the freezing of condensate propagates from the top surface of the side walls down toward the valley region.

During propagation of the freezing condensate from the top surface down toward the valley, the condensate is present on the 3D structure as both a solid and a liquid. The presence of the condensate on the 3D structure as both solid and liquid generates a concentration gradient that forms as a result of a saturation vapor pressure difference between the solid and the liquid. This concentration gradient causes the evaporation of liquid condensate in the valley, thus keeping the valley region frost-free.

The experiments were conducted with both polymeric and metal hexagonal periodic lattice structures, but such a textured surface can also be made from any other rigid materials and can incorporate any other shapes (such as square, or triangular lattice), tailored to the needs of a given application, as the effects of the design are independent of the surface chemistry, thermal characteristics, or other material properties. The 3D macro-texture can be manufactured by 3D printing, sheet metal forming, injection molding, and other methods depending on the application requirements such as the total weight or density of the functional macro-texture structure and optical/electromagnetic transparency. The range of the length and height of the side walls of the hexagon is from 0.1 millimeters (mm) to 10 mm. In alternative embodiments, different values can be used. The GO coating thickness was approximately 0.7 mm or thinner, depending on the implementation. These values can be further altered to control the frosting behavior.

This surface design is of great value due to its robust anti-frosting capabilities and facile scalability/manufacturability. This enables a practical solution to large scale anti-frosting surfaces that can be implemented in any number of ways. The addition of a porous, desiccating layer improves anti-frosting performance and is functionally robust to mechanical abrasions/damage. When combined, the surface textures provide anti-frosting capabilities over a broad range of operating conditions (including temperature, relative humidity, degree of subcooling, wind speed, etc.) while having the potential to be manufactured with high repeatability, low cost, and materials property control (such as structural density and weight) and having the mechanical durability to be practically implemented in real-world applications.

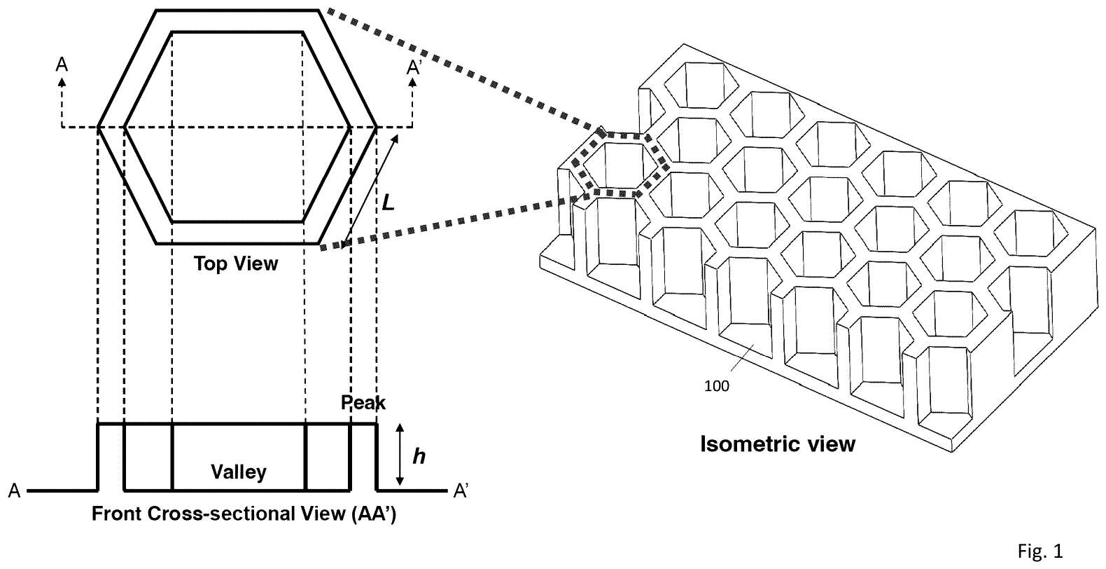

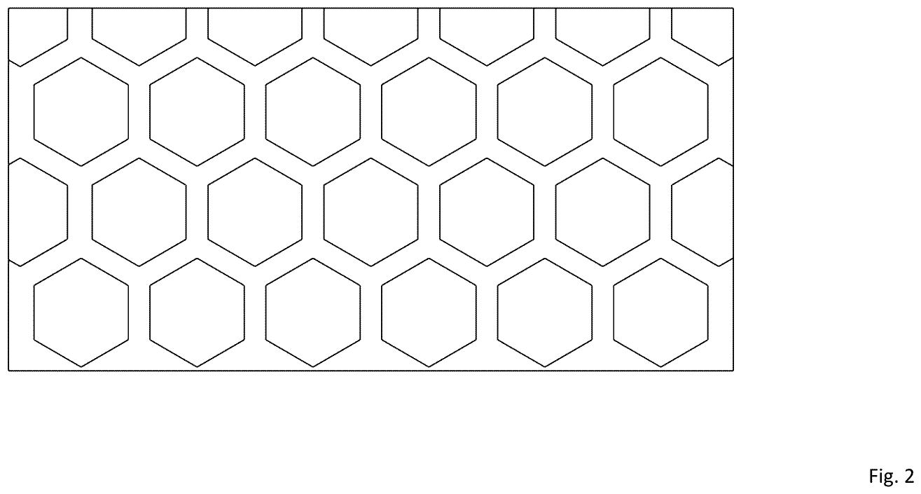

FIG. 1 depicts a surface that includes a periodic lattice of macro-textures in accordance with an illustrative embodiment. In the embodiment shown, the macro-textures are hexagons. In alternative embodiments, a different shape or shapes may be used. In addition to an orthogonal view of the periodic lattice, FIG. 1 also includes plan and front views of a macro-texture. As shown, the macro-textures are formed on a base (or substrate) 100. The base 100 can be the same material as the macro-textures or different, depending on the embodiment. As shown, the hexagonal macro-texture has sides of length L and a height h relative to the base 100. FIG. 2 is a top view of a surface with a periodic lattice of macro-textures in accordance with an illustrative embodiment.

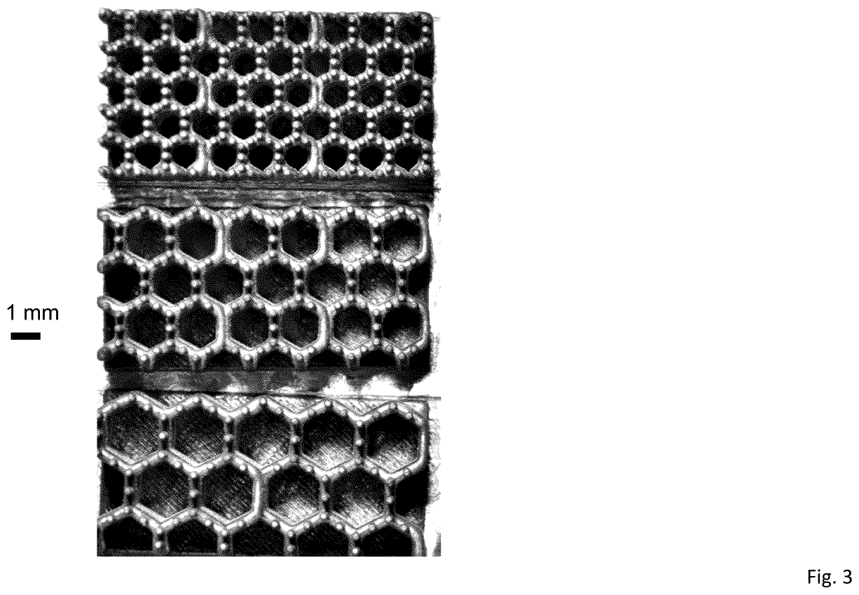

FIG. 3 depicts experiments conducted on various metallic samples in accordance with an illustrative embodiment. The samples in this embodiment are aluminum, although a different metal/material may be used to alter the thermal conductivity, which helps control the amount of frost formation. It was found that for metallic samples with a high thermal conductivity (such as aluminum), the frost-free valley region is observed for a longer period of time without the use of a GO (or other) coating. Experiments were conducted with variation in overall size (i.e., L) of the macro-textures, sidewall height h of the macro-textures, with hairy structure density variation, with and without coatings, and with varying relative humidity (RH). In the embodiment of FIG. 3, the size of the macro-textures was varied from 1 mm, to 1.5 mm, to 2 mm. Additionally, for the experiment of FIG. 3, the RH=30%, ambient temperature was 21° C, and base temperature was −10° C.

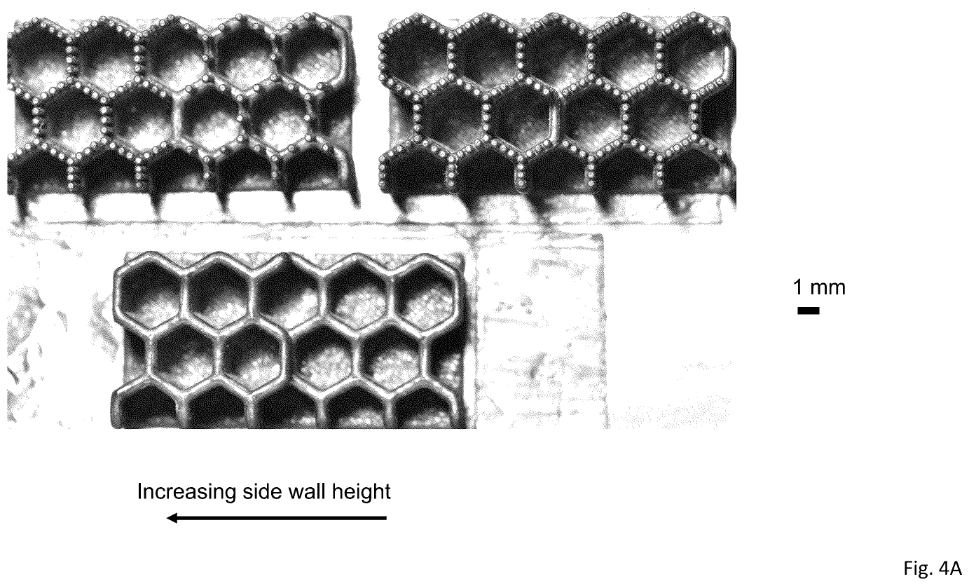

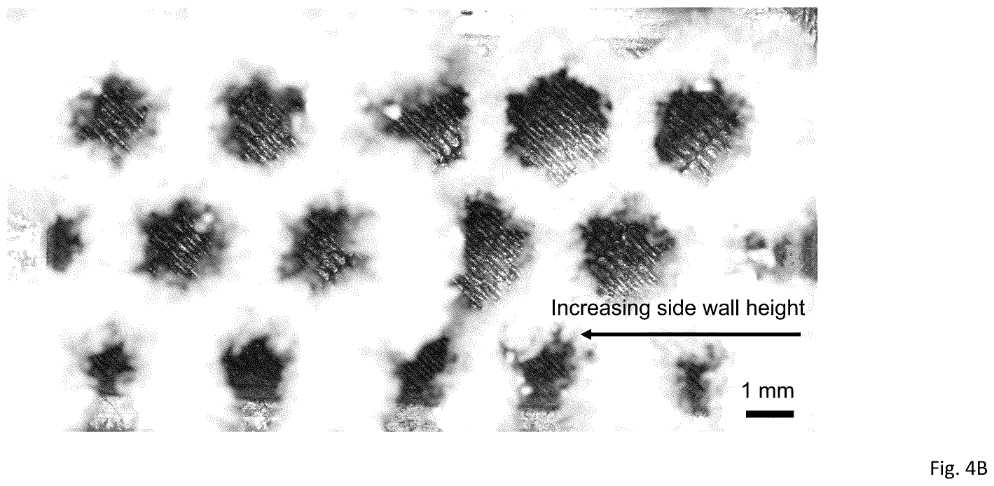

FIG. 4A depicts experiments conducted with metallic samples having macro-textures with varying sidewall height h in accordance with an illustrative embodiment. In the images shown, the height of the sidewalls increases from right to left. In the experiment of FIG. 4A, the RH=30%, ambient temperature was 21° C, and base temperature was −10° C. FIG. 4B is a plan view of frost-free valley regions of the experiments conducted with metallic samples having macro-textures with varying sidewall height h=4 mm and 6 mm, increasing from right to left in accordance with the illustrative embodiment. The image of FIG. 4B was captured after t=2.5 hours in the conditions referenced above. The macro-textures of FIGS. 4A and 4B do not have a GO or other applied coating.

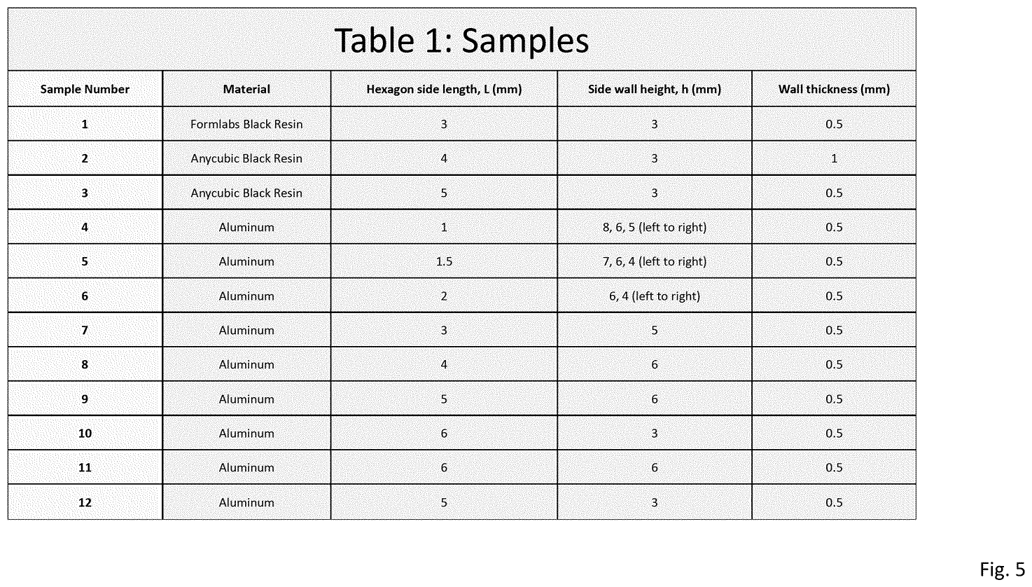

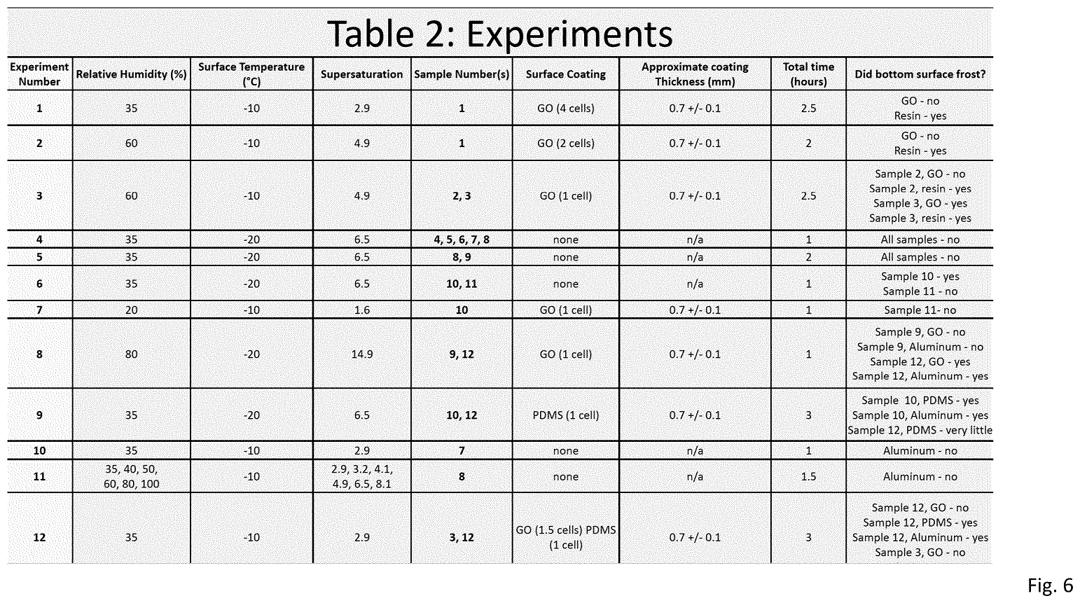

Based on information obtained from the experiments described with reference to FIGS. 2-4, twelve additional experiments were also conducted. A range of different geometric parameters tested are as follows: hexagon side length, L=1 mm-5 mm, hexagon side wall height, h=3 mm-8 mm, and hexagon wall thickness, t=0.5 mm-1 mm. Based on the results of these experiments and understanding of the physical mechanisms for frost resistance, a broader range of geometric parameters will achieve the desired frost resistance, ranging from L=0.1 mm-10 mm, and h=0.1 mm-10 mm. It is believed that the frost-resisting properties of the macro-texture can even apply e to a larger range of geometric parameter values, depending on the application and additional surface coating. Polymeric and metallic samples were tested, with the thermal conductivity of the materials ranging from 0.1 W/m-K-137 W/m-K, although samples will achieve the desired frost-resisting effects with thermal conductivities ranging from 0.1 W/m-K-400 W/m-K or higher. With respect to the moisture absorbent coating, Graphene Oxide (GO) and Polydimethylsiloxane (PDMS) were tested, both with a low thermal conductivity of around 0.1 W/m-K. It is noted that the GO coating performed better than the PDMS coating in resisting frost formation, due to its superior moisture-absorbing ability. In alternative embodiments, coatings with similar moisture-absorbent properties can be used instead of GO. Although hexagonally shaped periodic macro-textures were tested, the macro-texture shape is not limited to hexagons only. The periodic lattice can be of triangular, circular, or square shape. FIG. 5 is a table that depicts information regarding the materials tested in accordance with an illustrative embodiment. FIG. 6 is a table that depicts information regarding the experiments conducted in accordance with an illustrative embodiment.

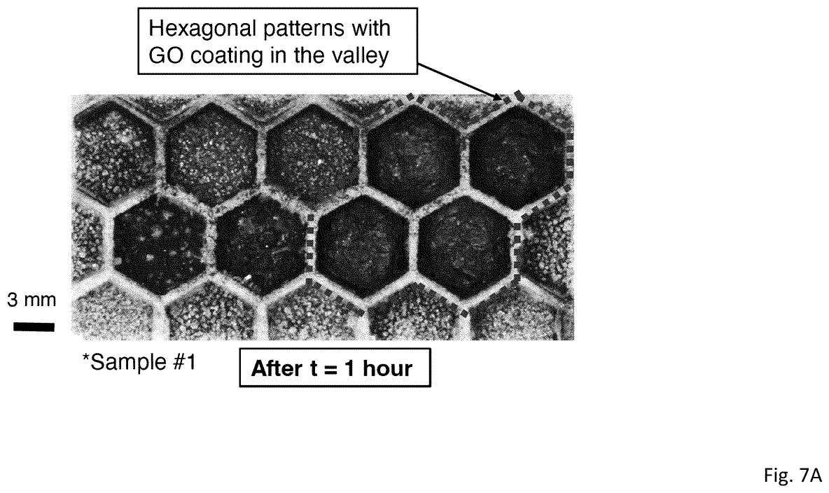

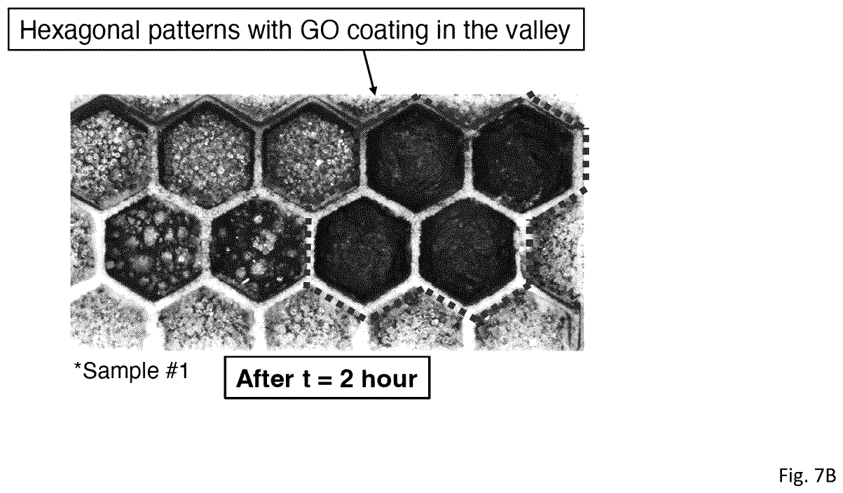

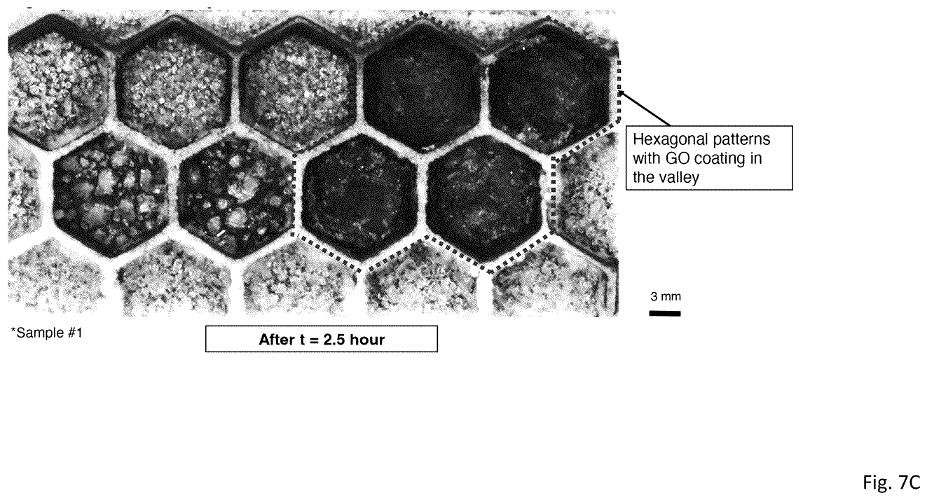

In a first experiment, valley regions of 4 adjacent hexagonal textures of a polymeric sample were coated with moisture-absorbent 2D-nanomaterial Graphene Oxide (the dotted region). Apart from the dotted region, the rest of the surface is not coated. The coated and non-coated regions show significant difference in frost-resisting ability under long-term frosting condition, and the combination of 3D macro textures with moisture-absorbent 2D nano-material results in a stable frost-resistant area. FIG. 7A shows the results of the first experiment after 1 hour in accordance with an illustrative embodiment. FIG. 7B shows the results of the first experiment after 2 hours in accordance with an illustrative embodiment. FIG. 7C shows the results of the first experiment after 2.5 hours in accordance with an illustrative embodiment. For the experiment, ambient temperature ≈21° C., base temperature Tₛ≈−10° C., relative humidity, RH=35%, (corresponding to a supersaturation of around 4), L=3 mm, and h=3 mm.

As shown in FIGS. 7A-7C, frost formation occurs on top of the hexagon side-walls, and gradually propagates into the valley, caused by the difference in focused diffusive flux over different regions (peak and valley regions), which results in a frost-free region in the valley for a longer time. It is shown that this effect of focused diffusive flux can be further enhanced by incorporating a moisture-absorbent thin coating in the valley region. This effect can be replicated over a large surface area by incorporating periodic lattice structure to achieve a functional and durable frost-resistant surface.

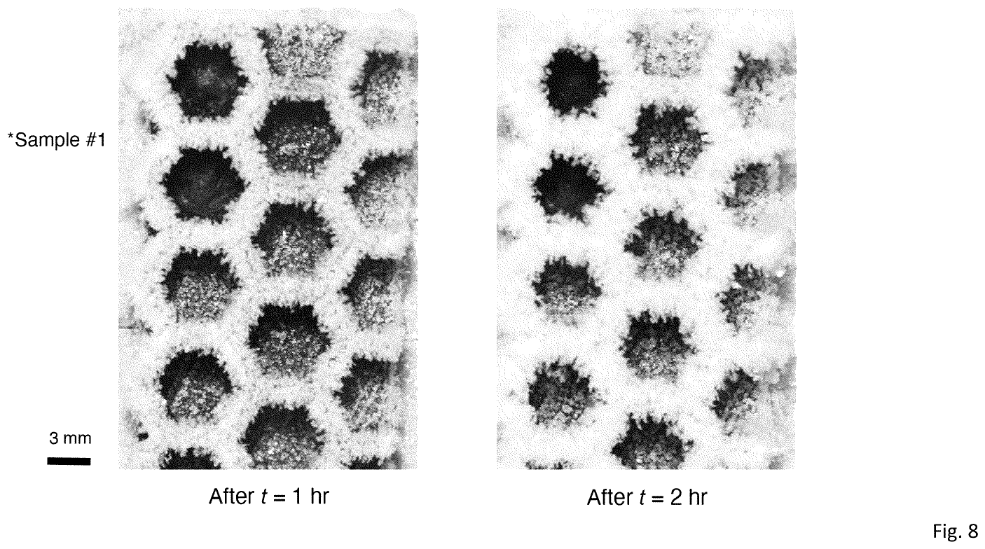

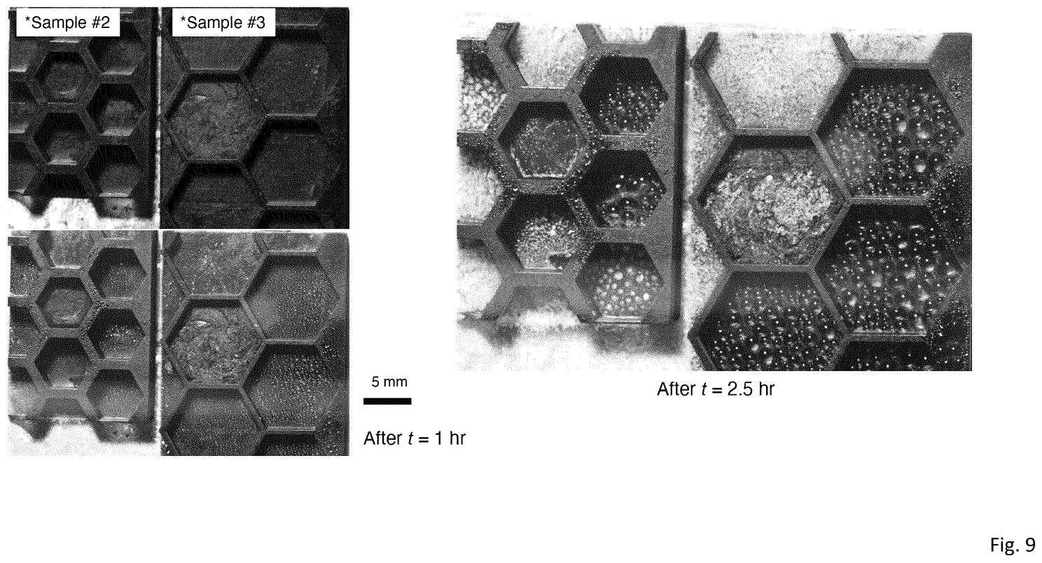

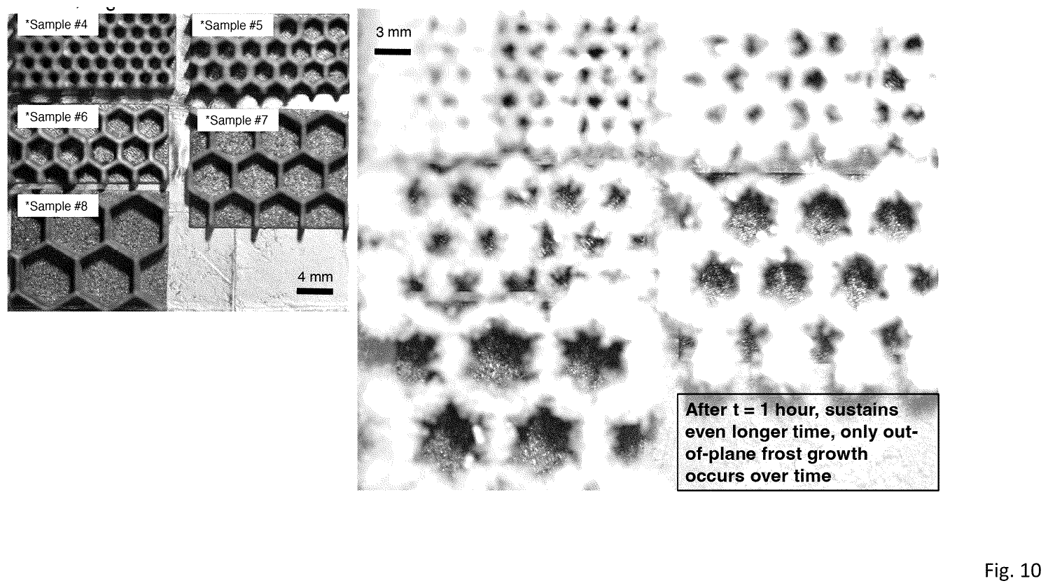

FIG. 8 depicts results of a second experiment with a polymeric sample in accordance with an illustrative embodiment. For the experiment depicted in FIG. 8, L=3 mm, h=3 mm, RH≈60%, and Tₛ=−10° C. A GO coating is applied to the two top-left hexagonal cells, where it is clearly seen that frost does not form here but does form in every other cell which does not contain GO. This indicates the effective application of a moisture-absorbing coating to prevent frost formation in the planar valley region for at least two hours. FIG. 9 depicts results of a third experiment with two polymeric samples in accordance with an illustrative embodiment. In the experiment of FIG. 9, L=4.5 mm, h=3 mm, RH≈60%, and Tₛ=−10° C. Both samples consist of two columns of fully enclosed hexagons, where a single hexagon in the left column, second from the top, contains a GO coating. This experiment demonstrates the effect of the sidewall length L on the effectiveness of a moisture-absorbing coating, where the GO coating undergoes frosting for the larger L=5 mm sample but remains frost-resistant for the L=4 mm sample. FIG. 10 depicts results of a fourth experiment with a metallic sample of varying wall length and height in accordance with an illustrative embodiment. None of these samples contained a GO coating. For this experiment, RH≈35% and Tₛ=−20° C. It was observed that for metallic samples with a high thermal conductivity (such as Aluminum), a frost-free valley region is generally observed for a longer period without the GO coating.

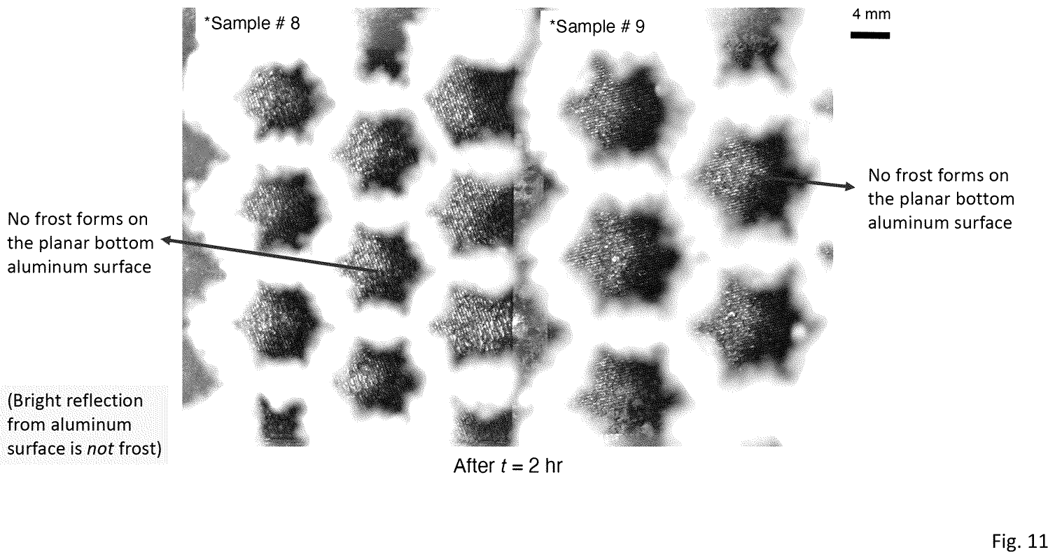

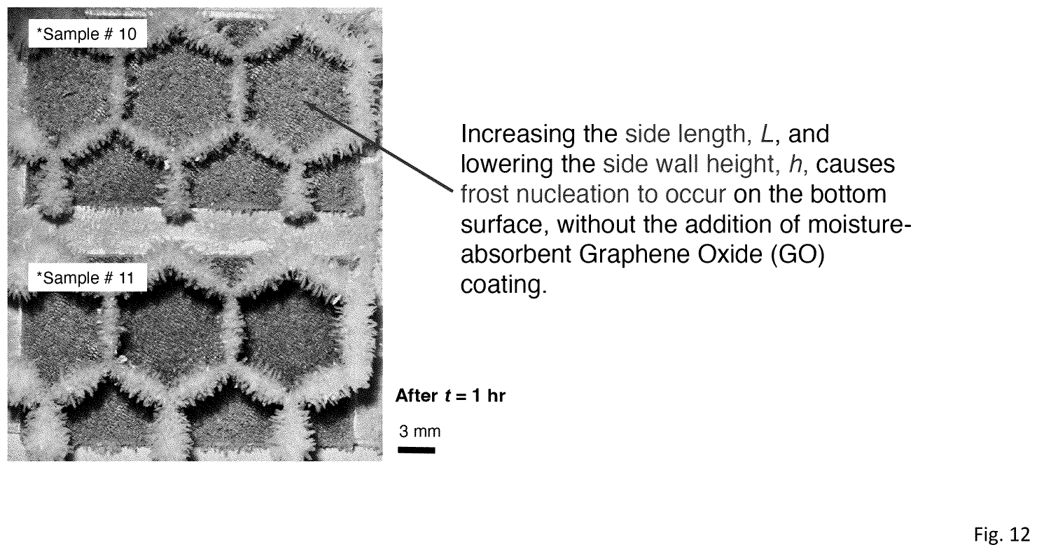

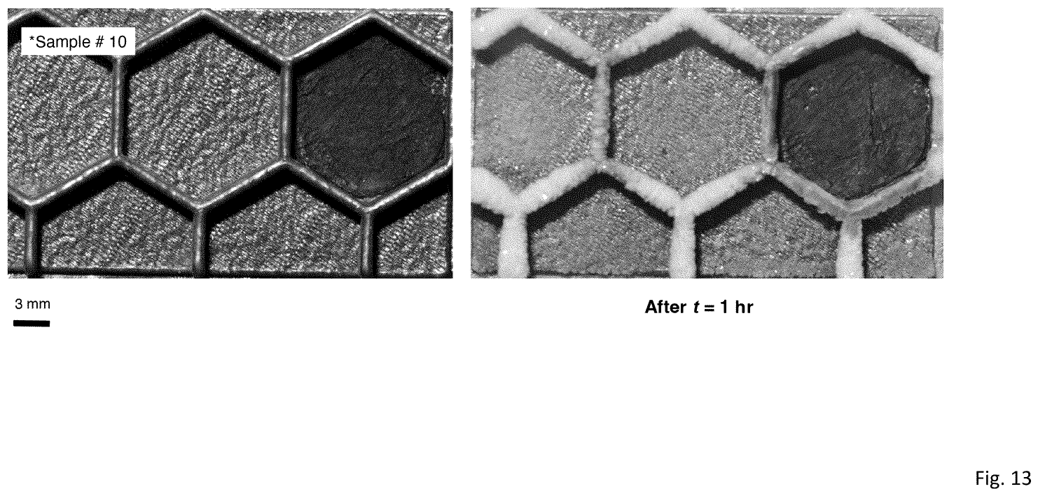

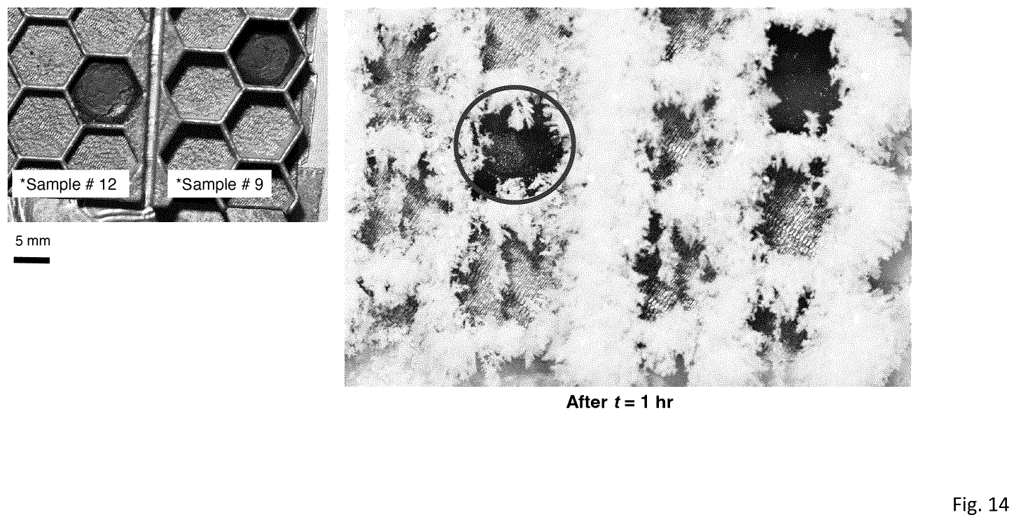

FIG. 11 depicts results of a fifth experiment with a metallic sample of varying wall length in accordance with an illustrative embodiment. In this experiment, L=4.5 mm, h=6 mm, RH≈35%, and Tₛ=−20° C. FIG. 12 depicts results of a sixth experiment with a metallic sample of varying wall height (and larger side wall length than that of the metallic sample in the fifth experiment) in accordance with an illustrative embodiment. In this experiment, L=6 mm, h=3.6 mm, RH≈35%, and Tₛ=−20° C. Results of this sixth experiment shows the failure of a metallic sample with lower side wall height under the above mentioned frosting condition while the metallic sample with higher side wall height can still resist frost formation on the bottom surface. FIG. 13 depicts results of a seventh experiment with a metallic sample in accordance with an illustrative embodiment. In this experiment, L=6 mm, h=3 mm, RH≈20%, and Tₛ=−10° C. In FIG. 13, it is noted that in a less harsh frosting condition, achieved by increasing the cold plate temperature and lowering the RH, a GO coating is effective in overcoming the previous failure of L=6 mm hexagons in suppressing frost formation on the bottom surface. FIG. 14 depicts results of an eighth experiment with two metallic samples in accordance with an illustrative embodiment. In this experiment, L=5 mm, h=3.6 mm, RH≈80%, and Tₛ=−20° C. Results of this eighth experiment shows that metallic samples with lower side wall height might show frost formation under prolonged and extreme frosting condition (80% RH), while samples with higher side wall height can still resist frost formation in this frosting condition if combined with GO coating.

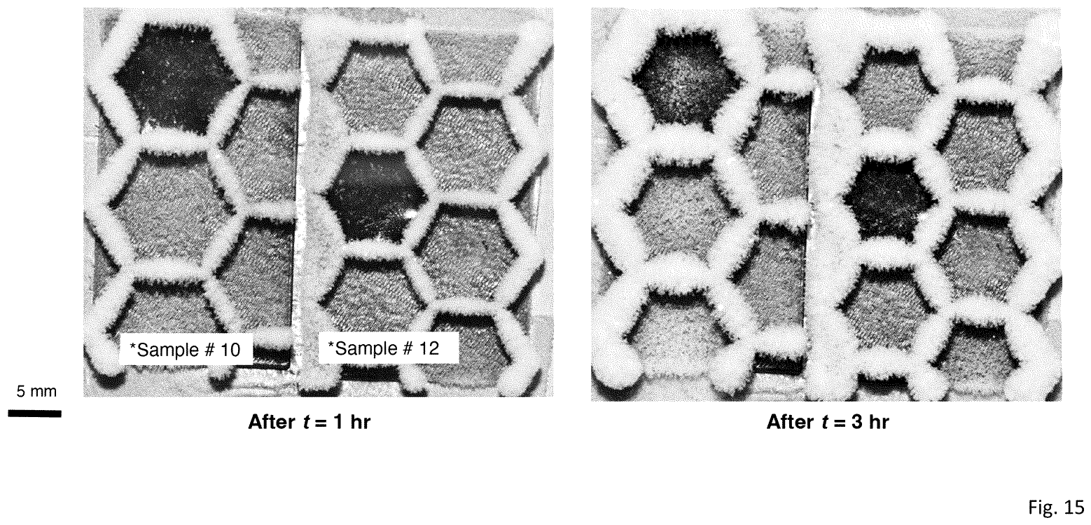

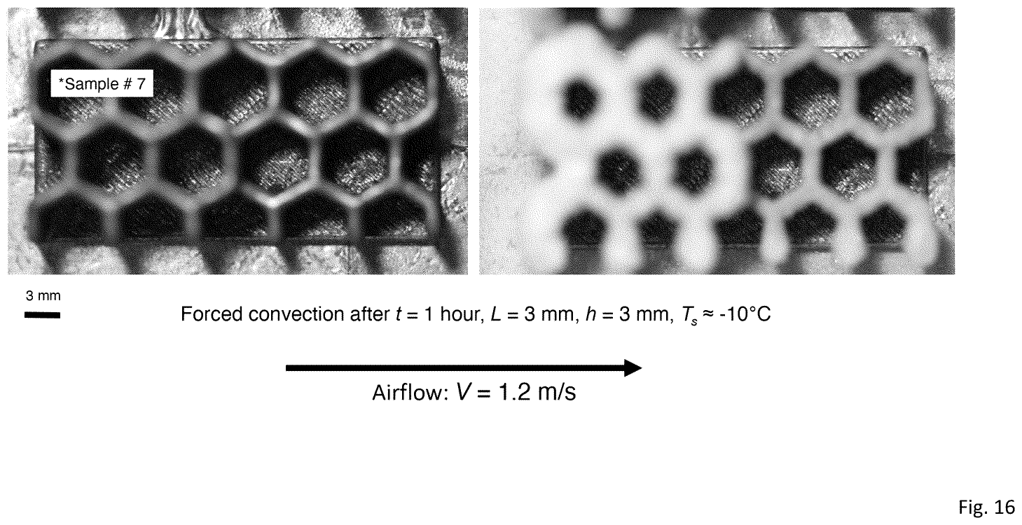

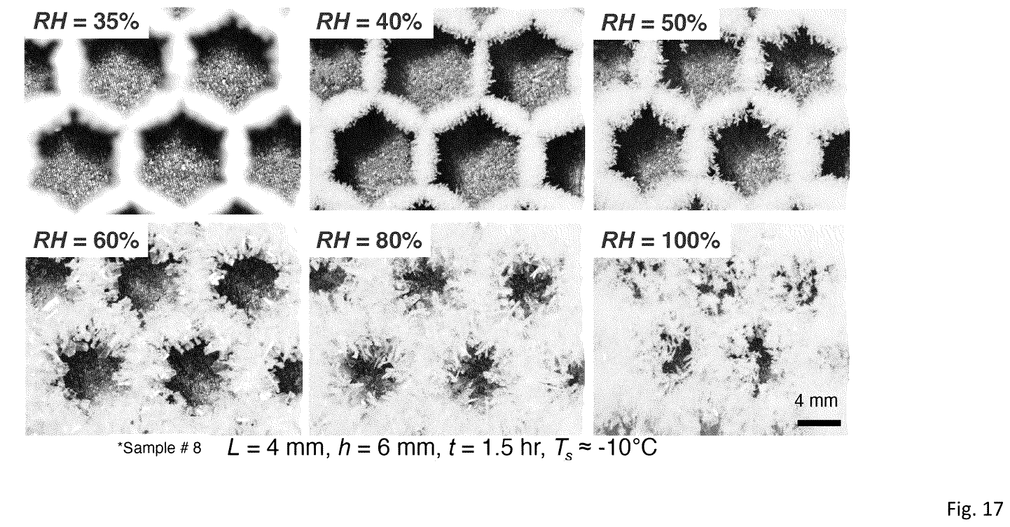

FIG. 15 depicts results of a ninth experiment with two different metallic samples with a PDMS coated cell in both of them, in accordance with an illustrative embodiment. In this experiment, L=5.6 mm, h=3 mm, RH≈35%, Tₛ=−20° C., and a PDMS coating was applied. A PDMS coating has similar thermal conductivity to a GO coating (˜0.1 W/m/K), but with vastly less moisture-absorbing capacity. FIG. 16 depicts results of a tenth experiment with forced convection in accordance with an illustrative embodiment. In this experiment, RH=35%, air velocity=1.2 m/s. Results of this tenth experiment shows the frost resistance and durability of this periodic lattice in dynamic environmental conditions with airflow. FIG. 17 depicts results of an eleventh experiment with relative humidity variation in accordance with an illustrative embodiment. In FIG. 17, relative humidity was varied between 35, 40, 50, 60, 80, and 100%. For the metallic sample tested in FIG. 17, the superiority of the hexagonal-textured geometry is shown, with no frost occurring on the bottom valley region even with a relative humidity condition of 100%.

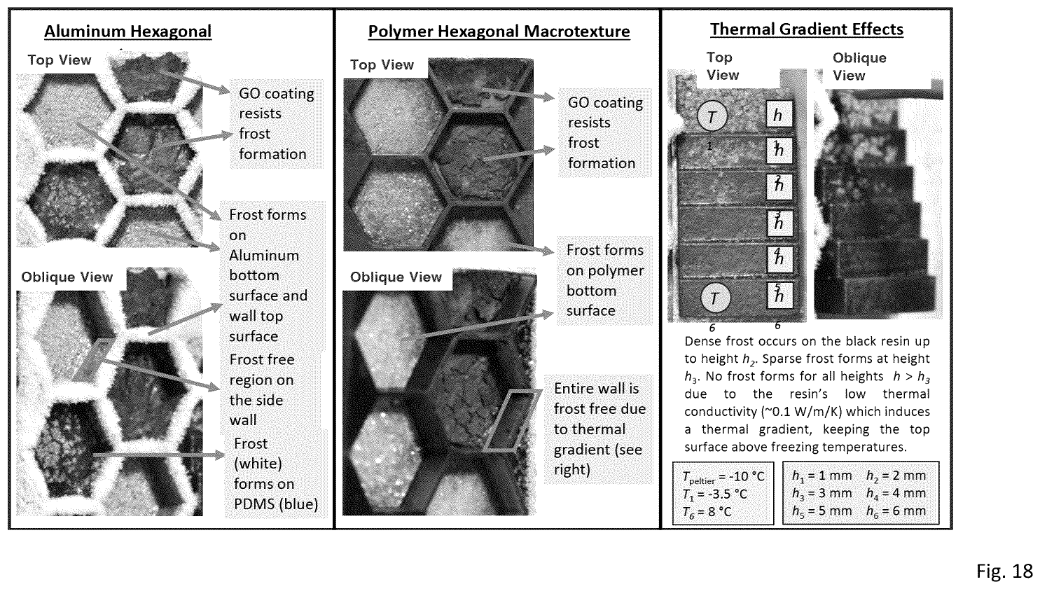

FIG. 18 depicts results of a twelfth experiment in accordance with an illustrative embodiment. In this experiment, RH=35%, Peltier Surface Temperature=−10° C., and t=3 hours. As shown, a comparison of frosting on aluminum (left) and polymer (center) hexagonal macrotextures containing GO surface coatings, under conditions where the macrotexture with side wall length L=5 mm and side wall height h=3 mm (*Samples #3 and #12) fails to resist frosting. As such, all exposed aluminum surfaces (surfaces that are not coated with GO coating) frost, except for a narrow frost-free region on the macrotexture sidewall due to the focused diffusion flux at the top surface of the wall. The polymer bottom surfaces frost as well but the macrotexture walls do not, due to the insulating properties of the polymer material which are described in the right panel. Regardless of the macrotexture material (aluminum or polymer) the GO-coated cells do not form any frost for over 3 hours. The aluminum sample also contains a PDMS-coated cell where PDMS has an approximately similar thermal conductivity to GO (˜0.1 W/m/K), which demonstrates that the superior anti-frosting ability of GO is not owed to its insulating properties but rather its hygroscopic (moisture-absorbing) properties. To that end, it is shown that the GO diffusion flux control supersedes any thermal anti-frosting effects for thin surface coatings. Furthermore, the GO material enhances the anti-frosting ability of the macrotexture, allowing for robust frost resistance under conditions which otherwise result in frosting of the bottom flat surfaces.

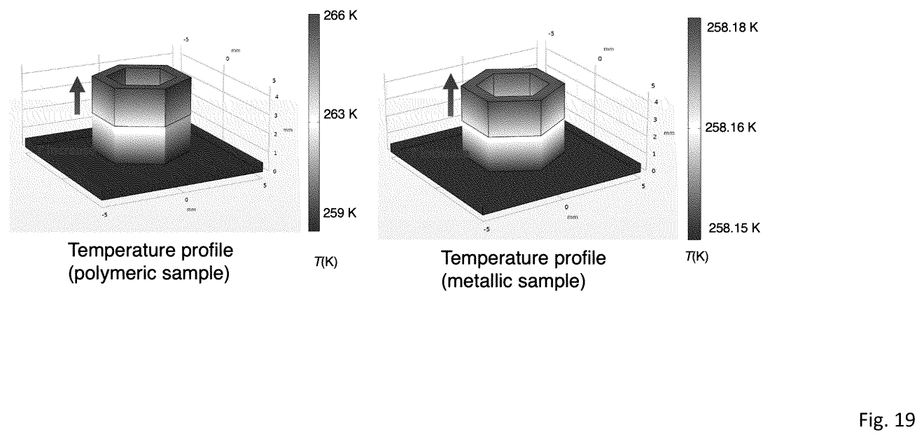

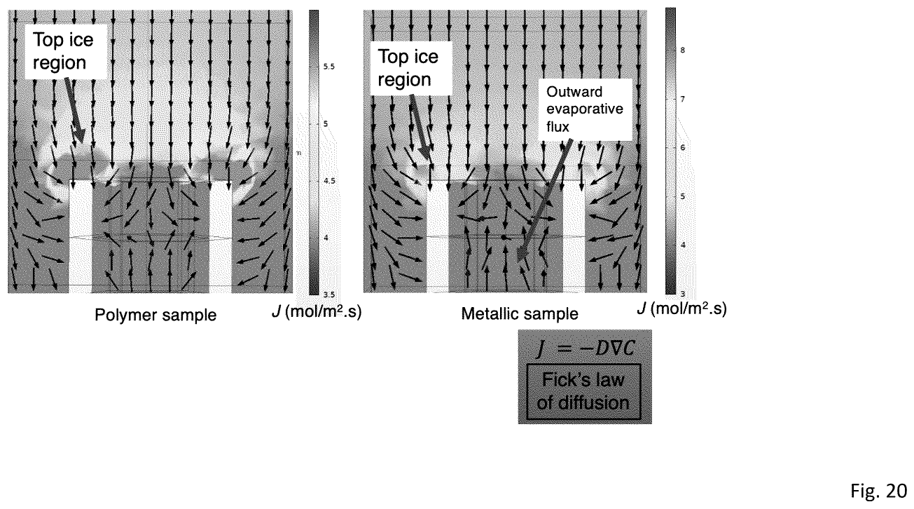

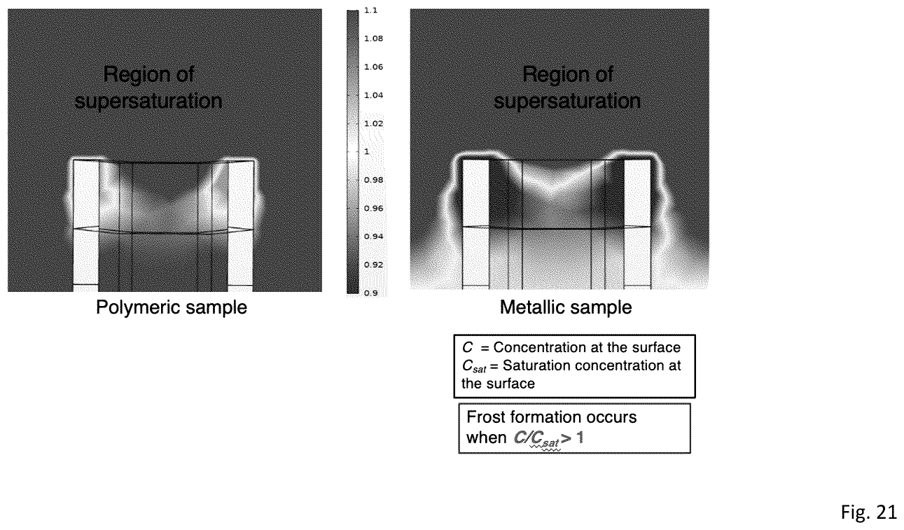

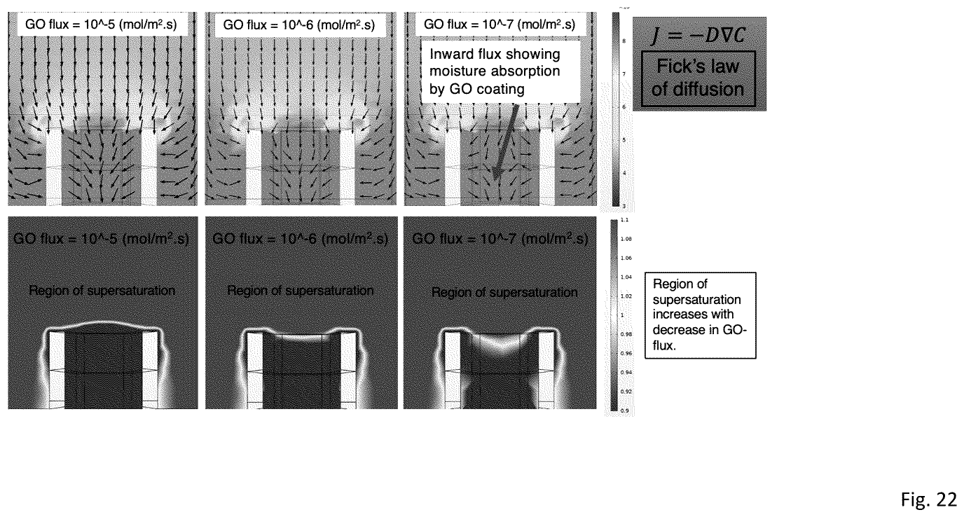

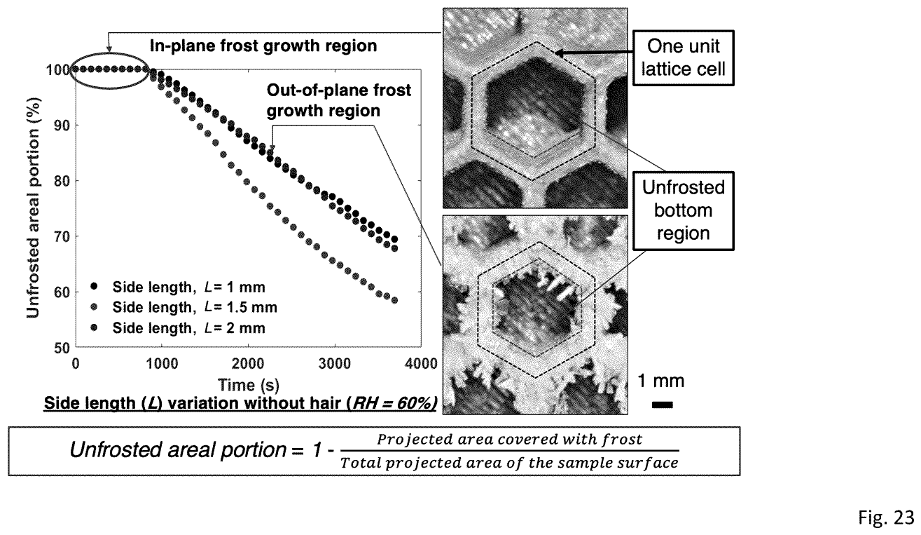

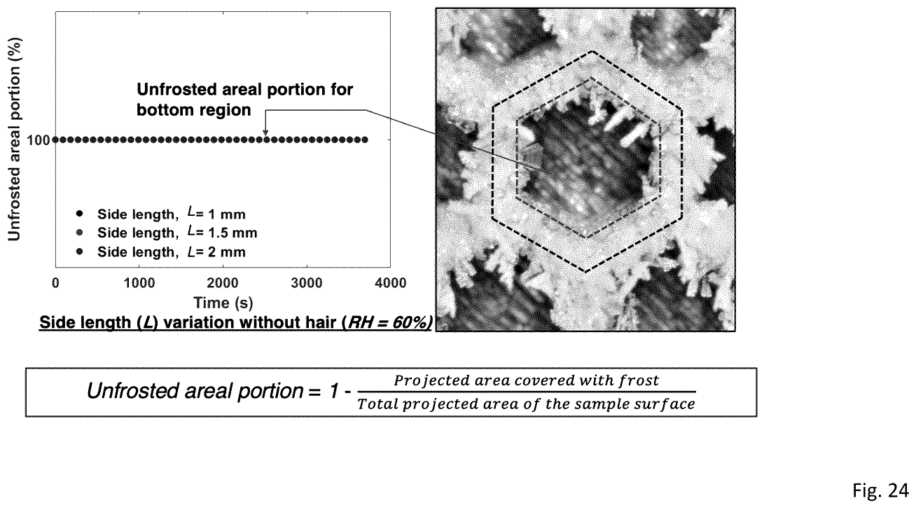

FIGS. 19-24 depict various results and conclusions derived from the above-discussed experiments. FIG. 19 depicts a temperature profile comparison between polymeric and metallic samples in accordance with an illustrative embodiment. FIG. 20 depicts a diffusive flux distribution between polymeric and metallic samples (geometry only, without GO coating) in accordance with an illustrative embodiment. As shown, a later stage of condensation frosting shows evaporation of droplets from the bottom valley region after condensation, with focused diffusion flux at the top of the hexagonal feature. FIG. 21 depicts distribution of c/cₛₐₜᵤᵣₐₜᵢₒₙ (normalized concentration field) (geometry only, without GO coating) for polymeric and metallic samples in accordance with an illustrative embodiment. When the partial pressure of ambient water vapor exceeds a critical supersaturation, heterogeneous nucleation will occur on any adjacent surface. As shown, the region of supersaturation for the polymeric sample is larger than that for metallic sample. FIG. 22 depicts simulation results of a metallic sample with a GO coating in the bottom of the hexagon in accordance with an illustrative embodiment, the simulations depicting the effect of increasing the GO flux that results in a decrease of the region of supersaturation. FIG. 23 quantifies an unfrosted areal portion of a metallic sample surface (with no GO coating) in accordance with an illustrative embodiment. FIG. 24 depicts that a 100% unfrosted areal portion can be achieved at the bottom surface of the metallic sample (with no GO coating) in accordance with an illustrative embodiment.

The surfaces described herein can be used for aircraft wings, heat exchangers, power cables, telephone lines, satellite dishes, optical and/or sensor applications (e.g., drones and robots that operate in cold weather), aerial devices, wind turbine blades, etc. As compared to traditional surfaces, the proposed surfaces provide an improvement in surface durability, ease of fabrication (i.e., of macro-textured surfaces as compared to nano-/micro-textured surfaces), much longer-term frost prevention over a surface, an enhanced ability to spatially control frost-formation, and scalability to create large-area functional anti-frost surfaces.

Thus, the proposed macro-textured surface meets the need for a functional, durable anti-frost surface that can resist frost formation for a significantly longer time than traditional surfaces. Also, the proposed surface design is independent of material type and provides a method to have spatial control over frost formation. Beyond frost/ice, selective deposition of materials is also critically important for many different manufacturing techniques, such as the fabrication of central processing unit (CPU) chips and battery cells. The design parameters that promote an anti-frost/ice region also can be utilized to have control over selective material deposition.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A method of forming a textured surface to prevent frost buildup, the method comprising:
forming a substrate;
forming a plurality of three-dimensional structures that attach to the substrate such that valleys are formed in between the three-dimensional structures;
controlling dimensions of each of the plurality of three-dimensional structures to generate a concentration gradient that forms as a result of a saturation vapor pressure difference between solid condensate and liquid condensate that forms on the textured surface, wherein the concentration gradient causes evaporation of the liquid condensate in the valleys that occur between the plurality of three-dimensional structures.

2. The method of claim 1, further comprising applying a coating to the valleys formed in between the three-dimensional structures.

3. The method of claim 2, further comprising applying the coating to the plurality of three-dimensional structures.

4. The method of claim 2, altering, by the coating, an overall diffusion field of the textured surface by adsorbing or desorbing vapor from the atmosphere.

5. The method of claim 2, wherein the coating comprises a moisture absorbent nanomaterial.

6. The method of claim 2, wherein the coating comprises graphene oxide.

7. The method of claim 1, wherein the three-dimensional structures are polygons, and wherein the controlled dimensions include a height of the side walls of the polygon and a length of a side of the polygon.

8. The method of claim 1, wherein the three-dimensional structures are hexagonal in shape.

9. The method of claim 1, wherein the three-dimensional structures are square, rectangular, circular, or triangular, or any other polygon in shape.

10. The method of claim 1, further comprising forming a periodic lattice structure on the substrate with the three-dimensional structures.

11. A textured surface comprising:
a substrate;
a plurality of three-dimensional structures attached to the substrate, wherein dimensions of each of the plurality of three-dimensional structures are controlled to generate a concentration gradient that forms as a result of a saturation vapor pressure difference between solid condensate and liquid condensate on the textured surface; and
valleys that are formed in between the plurality of three-dimensional structures, wherein the concentration gradient causes evaporation of the liquid condensate in the valleys.

12. The textured surface of claim 11, further comprising a coating applied to the valleys formed in between the three-dimensional structures.

13. The textured surface of claim 12, wherein the coating is also applied to the plurality of three-dimensional structures.

14. The textured surface of claim 12, where the coating alters an overall diffusion field of the textured surface by adsorbing or desorbing vapor from the atmosphere.

15. The textured surface of claim 12, wherein the coating comprises a moisture absorbent nanomaterial.

16. The textured surface of claim 12, wherein the coating comprises graphene oxide.

17. The textured surface of claim 11, wherein the three-dimensional structures are polygons, and wherein the controlled dimensions include a height of the side walls of the polygon and a length of a side of the polygon.

18. The textured surface of claim 11, wherein the three-dimensional structures are hexagonal in shape.

19. The textured surface of claim 11, wherein the three-dimensional structures are square, rectangular, circular, triangular, or a combinations of polygons in shape.

20. The textured surface of claim 11, wherein the three-dimensional structures form a period lattice structure on the substrate.
